(19) United States
(12) Patent Application Publication
(10) Pub. No.: US 2014/0231400 A1
(43) Pub. Date: Aug. 21, 2014

(54) COMBINATION WELDING GENERATOR-AIR COMPRESSOR WITH A SINGLE BELT DRIVE

(71) Applicant: Illinois Tool Works Inc., Glenview, IL (US)

(72) Inventor: Herbert A. Bankstahl, Appleton, WI (US)

(73) Assignee: ILLINOIS TOOL WORKS INC., Glenview, IL (US)

(21) Appl. No.: 14/171,958

(22) Filed: Feb. 4, 2014

Related U.S. Application Data
(60) Provisional application No. 61/767,537, filed on Feb. 21, 2013.

(51) Int. Cl. B23K 9/10; B23K 9/32

(52) U.S. Cl. CPC B23K 9/1006; B23K 9/32
USPC 219/133

(57) ABSTRACT

An integrated welder and air compressor combination includes a housing having an engine, weld current generator, and a belt-driven air compressor. A pulley arrangement is coupled to the engine, with the centers of the pulleys in a co-planar arrangement to enable driving the air compressor and engine accessory pulleys with a single belt. The engine accessory pulleys can drive, for example, one or more of an alternator, fan, or pump.

### CROSS-REFERENCE TO RELATED APPLICATIONS

This application claims priority to U.S. Provisional Application Ser. No. 61/767,537 filed Feb. 22, 2013, which is hereby incorporated by reference in its entirety.

### BACKGROUND OF INVENTION

The present invention relates generally to combined welder and compressor units, and more particularly to a unit of this type having a reduced number of movable parts.

Combined welding and compressor units transportable to a work site typically include an internal combustion engine and air compressor mounted to a frame. The internal combustion engine, compressor, alternator, and air tank assembly are mounted within a housing, typically extending along a length of the housing. The internal combustion engine is connected to a generator which generates welding amperage, and can also generate alternating current for operating external auxiliary equipment, which can include drills, grinders, lights and other devices. The air compressor can provide compressed air for pneumatic equipment as well as certain welding applications, including carbon arc gouging and plasma cutting.

While combined welder and compressor units operate satisfactorily, these types of systems have several disadvantages. These systems, for example, have many moving parts, and can be prone to high rates of mechanical breakdown. In particular, these systems often include complicated belt drives. There can be, for example, a number of different belts in the system, which are prone to wear at different rates. Each of these belts, therefore, can require maintenance, replacement, and repair. Repair costs, and welding unit downtime, can therefore be substantial.

There remains a need, therefore, for a welder and compressor unit that has decreased complexity, and reduced maintenance requirements, and which therefore has improved portability and durability. The present invention addresses these and other issues.

### SUMMARY OF THE INVENTION

In one aspect, the present disclosure provides an engine driven welder combination including a welder housing having internal components mounted thereto, and an engine mounted within the welder housing. The crankshaft of the engine is coupled to a weld current generator to generate an arc welding current. An air compressor is coupled to an air compressor drive pulley rotated by the engine. A belt is provided in driving engagement with the crankshaft pulley and the air compressor pulley, wherein when the engine rotates the crankshaft pulley, the belt drives the air compressor to produce compressed air.

The engine accessory can comprise a fan, a pump, or both. When the engine rotates the crankshaft pulley, the belt drives a fan hub or pump pulley to produce an air flow or fluid flow for cooling the engine.

A clutch assembly can be provided in driving engagement with the belt and coupled to the air compressor pulley, and can be selectively engaged to drive the air compressor to produce compressed air, and disengaged to prevent the production of compressed air. The clutch assembly can be, for example, a magnetic clutch assembly.

In another aspect, the present disclosure provides an engine driven welder combination comprising an engine coupled to a crankshaft pulley, an alternator drive pulley coupled to the engine and to an electrical generator configured to generate an electrical current when the alternator pulley is rotated, and an air compressor drive pulley rotatably coupled to the engine and coupled to an air compressor. The crankshaft pulley, the alternator drive pulley, and the air compressor drive pulley are mounted to the engine such that the center of each of the pulleys that is configured to receive a belt is co-planar with the centers of the other pulleys that are configured to receive a belt. A belt can be provided in driving engagement with each of the crankshaft pulley, the alternator drive pulley, and the air compressor pulley. When the engine rotates the crankshaft pulley, the belt drives the electrical generator to produce electrical current and drives the air compressor to produce compressed air.

In yet another aspect of the disclosure, an engine driven welder combination can comprise an engine coupled to a crankshaft pulley to drive the crankshaft pulley and to an electrical generator to generate an arc welding current; an air compressor coupled to an air compressor drive pulley rotated by the engine; an engine accessory coupled to an engine accessory drive pulley rotated by the engine; and a belt in driving engagement with the air compressor pulley and the engine accessory pulley. When the engine rotates the crankshaft pulley, the belt drives the air compressor to produce compressed air and the engine accessory. The engine driven welder combination can also include an alternator drive pulley coupled to the engine and to an electrical generator configured to generate an electrical current when the alternator pulley is rotated.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a perspective view of a combined welder and compressor unit;

FIG. 2 is a perspective view of an internal combustion engine and air compressor system for use in the combined welder and compressor unit of FIG. 1, and particularly a pulley assembly;

FIG. 3 is an end view of the engine and air compressor system of FIG. 2

FIG. 4 is an exploded view of the engine and air compressor system of FIG. 2.

FIG. 5 is an alternate perspective view of the engine and air compressor system of FIG. 2, taken from another angle.

### DETAILED DESCRIPTION

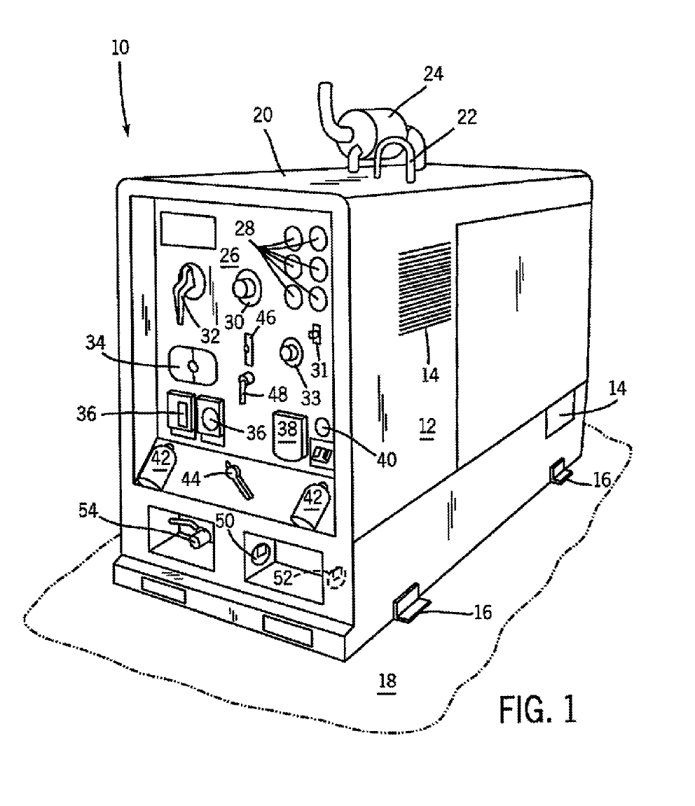

Referring now to FIG. 1, an exemplary portable engine-driven welding and compressor combination or system 10 is shown. Devices of this type are described, for example, in U.S. Pat. No. 6,674,046, which is hereby incorporated by reference for its description of welding and compressor combination devices. The welder combination 10 has an outer housing 12 that can include one or more air vents 14 for cooling internal components, and can be removed to permit access to the internal components for maintenance and service. A plurality of support members 16 can provide stabilization for the welder combination 10 when placed on a generally level surface, such as surface 18. An upper surface 20 of the welder combination 10 includes a lifting hook 22 extending therethrough. An exhaust system 24 can be attached to the upper surface 20 to lower noise and remove exhaust gas.

The welder combination 10 can include a control panel 26 that includes various control elements and gauges. A plurality of gauges 28 can be provided, for example, to measure various parameters, including oil pressure, fuel level, oil temperature, battery amperage, air pressure, and engine running time. Control panel 26 can also include an interface for selecting and adjusting a voltage or amperage range, here shown as a range switch 32 and corresponding control dial 30. A process selector switch 34 can be provided to select a type of weld output, and can include stick welding, TIG welding, air-carbon arc cutting, and various wire feed processes. Electrical outlets 36 can be provided in the control panel 26 to provide power for electrically driven devices, such as saws, drills, screw drivers, cooling devices, etc. Control panel 26 can also include a compressor on/off switch 31 and an engine control switch 33 for independent control of the compressor and engine, respectively.

The control panel 26 can also include a power connections for connecting auxiliary equipment, here shown as a single phase power connect outlet 38 and a three-phase power connect outlet 40, as well as weld-power receptacles 42 for receiving weld cables for use in a welding process. A polarity switch 44 can also be provided to enable a user to select the polarity of the weld output. Typical selections include direct current electrode negative, direct current electrode positive, and alternating current. In some embodiments, a panel remote switch 46 and remote receptacle 48 can be provided to enable a user to selectively control the welder combination 10 from a remote location. Positive 50 and negative 52 battery charge connections can also be provided to enable battery charging and jump starting. A valve 54 can be selectively activated by the user to supply compressed air from the air compressor for use in air assisted carbon arc cutting or to power air driven power tools and other pneumatic operations.

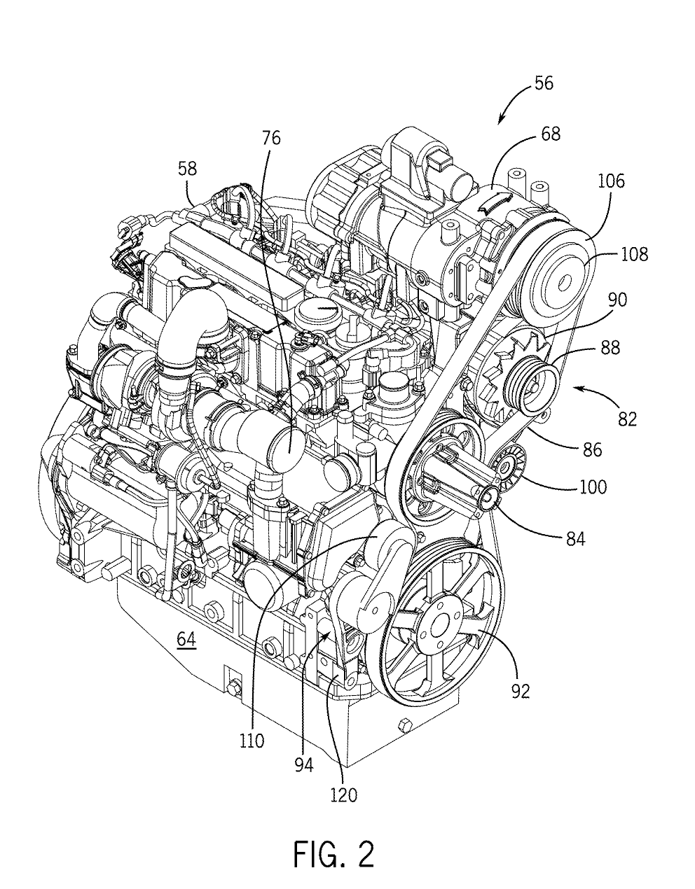

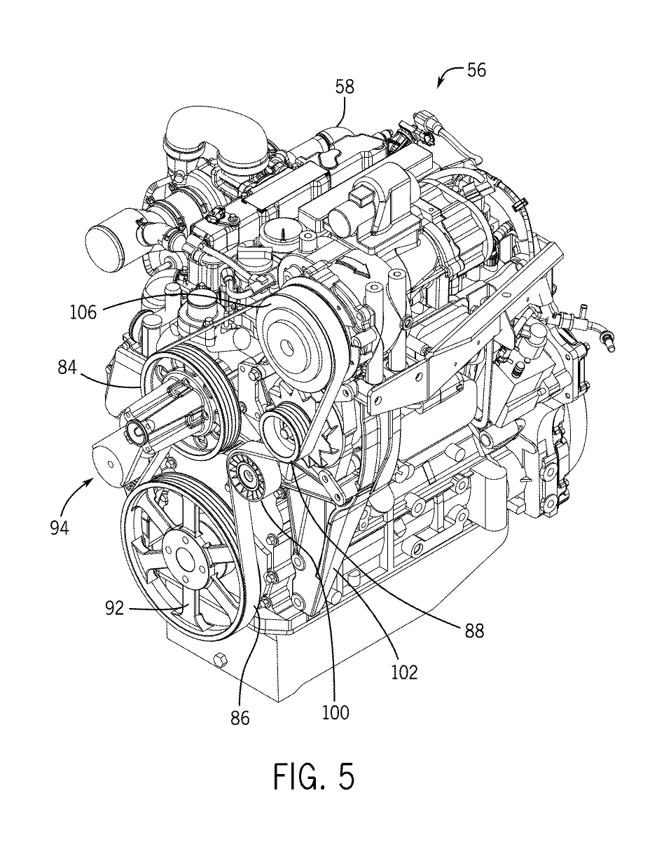

Referring now to FIGS. 2 and 5, perspective views of a portion 56 of the welder combination 10 of FIG. 1, with the housing 12 removed, are shown. An internal combustion engine 58 can be fluid or air cooled and configured to re-circulate engine cooling fluid. An electrical generator (not shown) configured to generate an arc welding current is mounted within the housing 12 of the welder combination 10 and is driven directly by the engine 58 to supply weld power to the weld-power receptacles 42. The welder combination further includes an air compressor 68, which can be, as shown here, a screw air compressor mounted to the engine 58. The air compressor 68 is configured to provide compressed air to the shut-off valve 54 of FIG. 1.

The internal combustion engine 58 of the welder combination 10 includes an air intake 76 connected to an intake manifold and engine head. A pulley arrangement 82 is coupled to the engine 58 and includes an air compressor pulley 106, an idler pulley 100, a crankshaft pulley 92, and engine accessory pulleys, here including an alternator pulley 88 and a fluid pump/fan blade hub 84. The pulleys in the pulley arrangement 82 are each sized and dimensioned to receive a drive belt 86, and are coupled to the engine and located in a plane such that the drive belt can be received and drive each of the pulleys simultaneously.

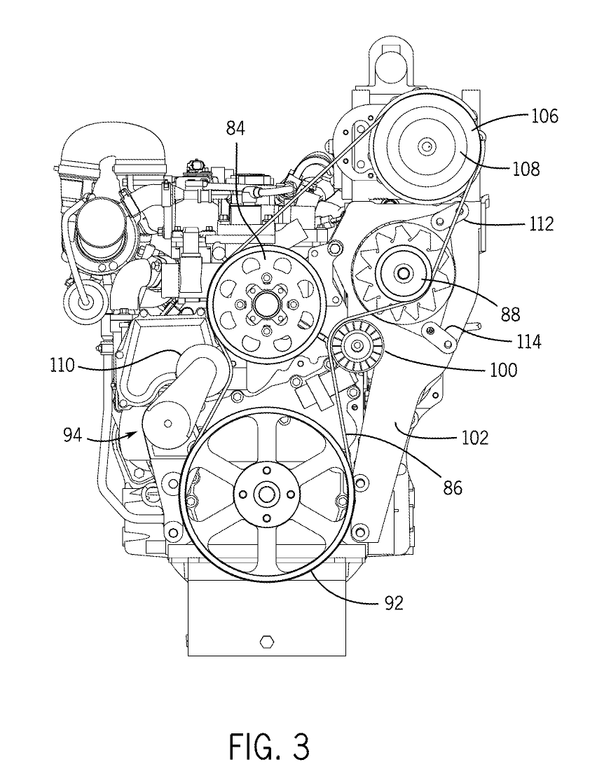

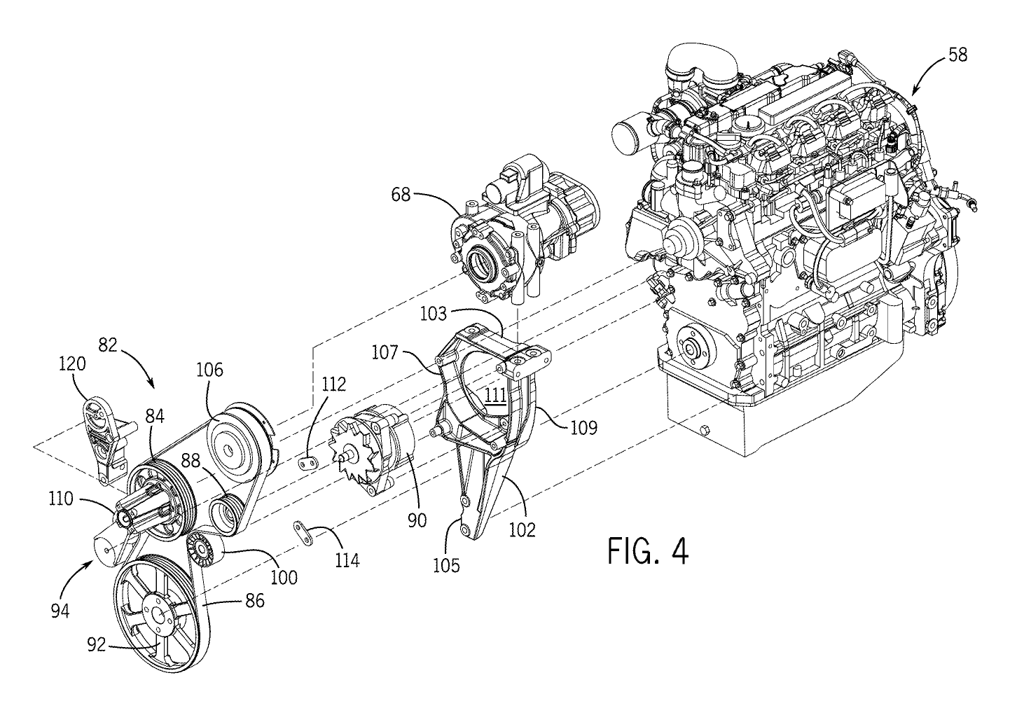

Referring still to FIGS. 2 and 5, and now also to FIGS. 3 and 4, to mount the air compressor 68 and alternator 90 to the engine 58, an air compressor mounting bracket 102 is bolted to the engine casing. The mounting bracket 102 includes an upper horizontal surface 103, a generally vertical lower coupling portion 105, and opposing side surfaces 107 and 109 which extend downwardly from opposing ends of the horizontal surface to the generally vertical lower coupling portion 105, defining an opening 111 therebetween for receiving the alternator 90. Brackets 112 and 114 are coupled between the alternator 90 and mounting bracket 102, and include holes for receiving threaded fasteners. The air compressor 68 is received on an upper horizontal surface 103 and is bolted to holes in the horizontal surface 103, retaining the air compressor 68 above the engine 58. A belt tensioner mounting bracket 120 is also coupled to the engine 58 with threaded fasteners, and includes additional holes to mount the belt tensioner 94. When the air compressor 68 and alternator 90 are received on the air compressor mounting bracket 102, the bracket 102 is sized and dimensioned to align the air compressor pulley 106 and alternator pulley 88 with the other pulleys in the pulley system 82, such that the pulleys are co-planar, thereby minimizing the length of the welding system 10. The belt tensioner mounting bracket 120 similarly positions the belt tensioner 94 adjacent the path of the belt 86.

Referring now to FIGS. 2, 3, and 4, the crankshaft pulley 92 drives the drive belt 86, which in turn drives the air compressor pulley 106, and engine accessory pulleys, here shown as alternator pulley 88 and fluid pump/fan blade hub pulley 84. A belt tensioner 94 connected to a mounting bracket 120 on the engine block adjacent the engine crankshaft pulley 92 and fluid pump/fan hub 84, includes a roller 110 that maintains tension on the drive belt 86 as the belt moves between the crankshaft pulley 92 and fluid pump/fan hub 84. The idler pulley 100 is coupled to the engine block adjacent the fluid pump/fan hub 84 and alternator pulley 88, and maintains tension on the belt 86 as it moves between these components.

In operation, when the engine is activated, the crankshaft pulley 92 is rotated by the engine 58, causing the drive belt 86 to drive the remaining pulleys in the system. The idler pulley 100 and roller 110 in the belt tensioner 94 maintain tension on the drive belt 86 as the belt moves. When the belt 86 drives the fluid pump/fan hub 84, the hub rotates, causing fan blades (not shown) to rotate to cause air flow through the housing 12 to cool the engine 58. A fluid pump for cooling the engine 58 can also be activated by rotation of the hub 84, either in combination with or separately from a fan. The fluid can be water, hydraulic fluids, or other types of fluids.

As the belt 86 drives the alternator pulley 88, the pulley 88 drives the alternator 90 to produce battery charging current. The air compressor pulley 106 can be coupled to a clutch assembly 108 which is also driven by the belt 86, and which can be engaged to drive a screw air compressor 68 to produce compressed air accessible at the valve 54, described above, and can be disengaged when the air compressor is not in use. The clutch assembly 108 can be, for example, a magnetic clutch assembly.

In one embodiment, the welding and compressor system 10 described above therefore uses an engine and a single belt to drive a number of different systems to produce power, provide cooling using both air and fluid, and provide mechanical force for use in auxiliary application, such as compressed air or pressurized fluids. This system provides a significant advantage as compared to prior art systems, because there are a reduced number of moving parts, and reduced maintenance requirements. As a result, equipment downtime can also be reduced. Further, because the pulleys are rotatably coupled to an end of the engine 58, and in a co-planar arrangement wherein the centers of each of the pulleys that receive the belt are in the same plane, the overall length of the welder combination 10 can be reduced as compared to prior art devices.

It should be understood that the methods and apparatuses described above are only exemplary and do not limit the scope of the invention, and that various modifications could be made by those skilled in the art that would fall under the scope of the invention. For example, although a single belt is shown here, in alternate applications, one or more belt could be used to drive a plurality of co-planar pulleys. To apprise the public of the scope of this invention, the following claims are made:

I/we claim:

1. An engine driven welder combination comprising:
a welder housing;
an engine mounted within the welder housing, the engine coupled to drive a crankshaft pulley and to an electrical generator to generate an arc welding current;
an air compressor coupled to an air compressor drive pulley rotated by the engine;
an engine accessory coupled to an engine accessory drive pulley; and
a belt in driving engagement with the air compressor pulley and the engine accessory pulley, wherein when the engine rotates the crankshaft pulley, the belt drives the air compressor to produce compressed air and the engine accessory.

2. The engine driven welder combination of claim 1, wherein the engine accessory comprises a fan, and the engine accessory pulley comprises a fan hub in driving engagement with the belt, wherein when the engine rotates the crankshaft pulley, the belt drives the fan hub to produce an air flow for cooling the engine.

3. The engine driven welder combination of claim 1, wherein the engine accessory comprises a fluid pump, and the engine accessory pulley comprises a fluid pump pulley in driving engagement with the belt, wherein when the engine rotates the crankshaft pulley, the belt drives the fluid pump to produce a fluid flow for cooling the engine.

4. The engine driven welder combination of claim 1, further comprising a clutch assembly in driving engagement with the belt and coupled to the air compressor pulley, wherein the clutch assembly is selectively engaged to drive the screw air compressor to produce compressed air and is selectively disengaged to prevent the production of compressed air.

5. The engine driven welder combination of claim 4, wherein the clutch assembly is a magnetic clutch assembly.

6. An engine driven welder combination comprising:
an engine coupled to a crankshaft pulley;
an alternator drive pulley coupled to the engine and to an electrical generator configured to generate an electrical current when the alternator pulley is rotated;
an air compressor drive pulley rotatably coupled to the engine and coupled to an air compressor,
wherein the crankshaft pulley, the alternator drive pulley, and the air compressor drive pulley are mounted to the engine such that the center of each of the pulleys that is configured to receive a belt is co-planar with the centers of the other pulleys that are configured to receive a belt.

7. The engine driven welder combination of claim 6, further comprising a belt in driving engagement with each of the crankshaft pulley, the alternator drive pulley, and the air compressor pulley, wherein when the engine rotates the crankshaft pulley, the belt drives the electrical generator to produce electrical current and drives the air compressor to produce compressed air.

8. The engine driven welder of claim 7, further comprising an engine accessory pulley coupled to an engine accessory in driving engagement with the belt for driving the engine accessory.

9. The engine driven welder of claim 8, wherein the engine accessory comprises a fluid pump.

10. The engine driven welder of claim 8, wherein the engine accessory comprises a fan.

11. The engine driven welder of claim 6, further comprising a clutch assembly in driving engagement with the belt and coupled to the air compressor pulley, wherein the clutch assembly is selectively engaged to drive the screw air compressor to produce compressed air and is selectively disengaged to prevent the production of compressed air.

12. The engine driven welder combination of claim 11, wherein the clutch assembly is a magnetic clutch assembly.

13. An engine driven welder combination comprising:
an engine coupled to a crankshaft pulley to drive the crankshaft pulley and to an electrical generator to generate an arc welding current;
an air compressor coupled to an air compressor drive pulley rotated by the engine;
an engine accessory coupled to an engine accessory drive pulley rotated by the engine; and
a belt in driving engagement with the air compressor pulley and the engine accessory pulley, wherein when the engine rotates the crankshaft pulley, the belt drives the air compressor to produce compressed air and the engine accessory.

14. The engine driven welder combination of claim 13, further comprising an alternator drive pulley coupled to the engine and to an electrical generator configured to generate an electrical current when the alternator pulley is rotated;

15. The engine driven welder combination of claim 13, wherein the engine accessory comprises a fan, and the engine accessory pulley comprises a fan hub in driving engagement with the belt, wherein when the engine rotates the crankshaft pulley, the belt drives the fan hub to produce an air flow for cooling the engine.

16. The engine driven welder combination of claim 13, wherein the engine accessory comprises a fluid pump, and the engine accessory pulley comprises a fluid pump pulley in driving engagement with the belt, wherein when the engine rotates the crankshaft pulley, the belt drives the fluid pump to produce a fluid flow for cooling the engine.

17. The engine driven welder combination of claim 13, further comprising a clutch assembly in driving engagement with the belt and coupled to the air compressor pulley, wherein the clutch assembly is selectively engaged to drive the screw air compressor to produce compressed air and is selectively disengaged to prevent the production of compressed air.

18. The engine driven welder combination of claim 17, wherein the clutch assembly is a magnetic clutch assembly.

19. The engine driven welder combination of claim 13, wherein the crankshaft pulley, the air compressor drive pulley, and the engine accessory pulley are mounted to the engine such that the center of each of the pulleys that is configured to receive a belt is co-planar with the centers of the other pulleys that are configured to receive a belt.
